(19) United States
(12) Patent Application Publication
(10) Pub. No.: US 2024/0355539 A1
(43) Pub. Date: Oct. 24, 2024

(54) HEADER ASSEMBLY WITH INTEGRATED CHOKE FOR POWER PACK

(71) Applicant: Steering Solutions IP Holding Corporation, Saginaw, MI (US)

(72) Inventors: Steven J. Collier-Hallman, Frankenmuth, MI (US); Delynn M. Streng, Freeland, MI (US); Daniel J. Klenk, Saginaw, MI (US); Ryan D. Yaklin, Chesaning, MI (US)

(21) Appl. No.: 18/358,095

(22) Filed: Jul. 25, 2023

Related U.S. Application Data
(60) Provisional application No. 63/460,131, filed on Apr. 18, 2023.

(51) Int. Cl. H01F 37/00; B62D 5/04; H01F 1/14; H01F 17/04

(52) U.S. Cl. CPC H01F 37/00; B62D 5/04; H01F 1/14; H01F 17/04; H01F 2017/0093

(57) ABSTRACT

A header assembly for a power pack assembly includes a frame. The header assembly also includes a core disposed on or within the frame. The header assembly further includes a conductor busbar extending through the core and secured to the frame, wherein the conductor busbar has a round cross-section.

### CROSS-REFERENCE TO RELATED APPLICATION

This application claims the benefits of priority to U.S. Provisional Patent Application Ser. No. 63/460,131, filed Apr. 18, 2023, the disclosure of which is incorporated by reference herein in its entirety.

### FIELD OF THE INVENTION

The present disclosure relates to vehicle power pack assemblies and, more specifically, to such assemblies having a header assembly with an integrated choke.

### BACKGROUND

Vehicle steering systems may benefit from a power pack assembly that provides electrical power for one or more functions associated with the steering system. A header assembly connects various electrical components with each other. Header assemblies can be expensive and contribute a significant amount of resistance to the controller resistance budget. In standard frame versions there is a common mode choke that is assembled separately and then assembled into the lead frame. In a large frame version, two differential mode chokes are assembled separately and then assembled into the lead frame. A simplified header assembly design that reduces cost and improves performance and reliability would be well received in various industries.

### SUMMARY OF THE DISCLOSURE

According to one aspect of the disclosure, a header assembly for a power pack assembly includes a frame. The header assembly also includes a core disposed on or within the frame. The header assembly further includes a conductor busbar extending through the core and secured to the frame, wherein the conductor busbar has a round cross-section.

According to another aspect of the disclosure, a header assembly for a power pack assembly in a vehicle steering system includes a frame. The header assembly also includes a first core disposed on or within the frame. The header assembly further includes a second core disposed on or within the frame. The header assembly yet further includes a first conductor busbar extending through the first core and extending through a hole defined by the frame, wherein the first conductor busbar has a round cross-section. The header assembly also includes a second conductor busbar extending through the second core and extending through a hole defined by the frame, wherein the second conductor busbar has a round cross-section.

These and other advantages and features will become more apparent from the following description taken in conjunction with the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view of a header assembly for a power pack assembly;

FIG. 1A is a disassembled view of the header assembly of FIG. 1;

FIG. 2 is a plan view of a header assembly according to another aspect of the disclosure;

FIG. 3 is a plan view of a header assembly according to another aspect of the disclosure;

FIG. 4 is a perspective view of a header assembly according to another aspect of the disclosure; and

FIG. 5 is a plan view of the header assembly of FIG. 4.

### DETAILED DESCRIPTION

Referring now to the Figures, where the invention will be described with reference to specific embodiments, without limiting same, a header assembly for a motor power pack assembly is disclosed. The power pack assembly is an assembly that provides power to one or more systems of a vehicle steering system. For example, electric power steering (EPS) systems that provide a user with an electric-based assist for steering efforts may benefit from the embodiments disclosed herein.

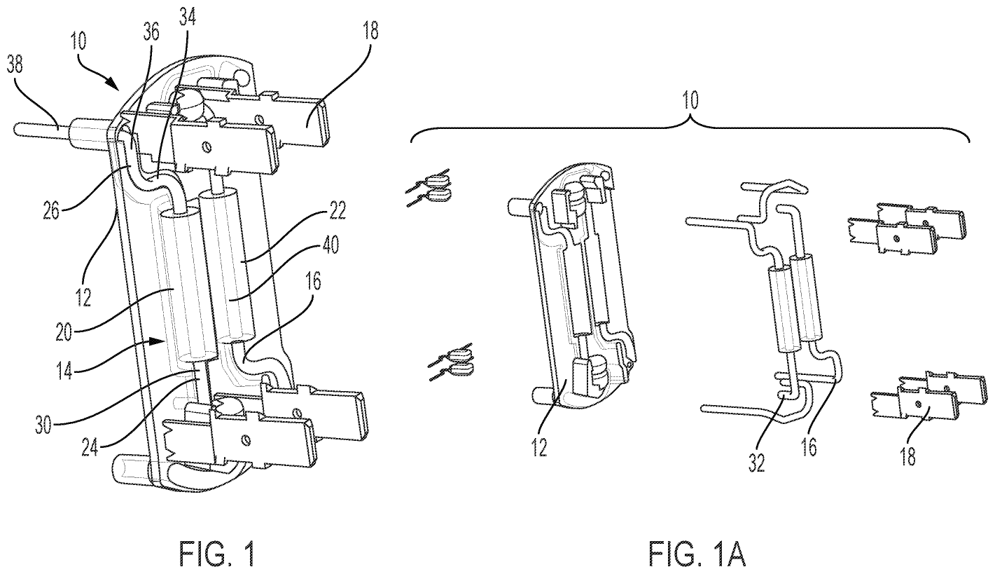

Referring to FIGS. 1 and 1A, a first embodiment of the header assembly is shown and is generally referenced with numeral 10. The header assembly 10 includes a frame 12 with contours to receive at least one core 14, conductor wire busbars 16, and a plurality of battery terminals 18. The frame 12 may be a plastic molded component in some embodiments, but it is to be appreciated that other suitable materials are contemplated. The contours of the frame 12 may be in the form of recesses or the like to allow the core(s) 14, busbars 16 and battery terminals 18 to be received therein in a fully assembled condition.

The header assembly 10 of FIGS. 1 and 1A includes a differential mode choke arrangement. Instead of separately wound chokes, the header assembly 10 disclosed herein utilizes one or more hollow cylindrical choke cores 14 with a single conductor disposed in each of the core(s), with the conductors being the conductor wire busbars 16. The conductor 16 is round copper wire in some embodiments, but it is contemplated that other materials may be utilized in other embodiments.

In the illustrated embodiment, a first core 20 and a second core 22 are provided. The conductor 16 is also used as a busbar, as disclosed above. By using a round conductor, the volume of material used in the choke cores 14 may be minimized. Additionally, since round conductors are easily bent in any axis, the busbars 16 can be manufactured with low to no waste and formed with a CNC wire bender. Prior busbars are stamped from flat stock, which results in waste when stamping. Additionally, flat stock only bends easily in one axis and that can complicate the design. With flat stock any change to the busbar dimensions requires new stamping dies. With the round busbars 16 disclosed herein, most changes may be accomplished by changing the program in the wire bender.

The illustrated example shows each busbar 16 as having a main segment 24 and a plurality of additional segments 26. The main segment 24 extends longitudinally along the frame 12 and through the respective core 14. The plurality of additional segments 26 may vary by number, lengthy and relative orientation to each other and the main segment 24. By way of non-limiting example, a first busbar 30 includes the main segment 24 extending through the first core 20, a first end segment 32 extending into the frame 12 and oriented at an angle substantially perpendicular to the main segment 24. At a second end of the first busbar 30, a first additional segment 34, a second additional segment 36 and a third additional segment 38 are included. The first additional segment 34 extends from the main segment 24 and extends substantially perpendicular to the main segment 24. The second additional segment 36 extends from the first additional segment 34 and extends substantially perpendicular to the first additional segment 34. The third additional segment 38 extends from the second additional segment 36 and extends substantially perpendicular to the second additional segment 36 and into the frame 12.

A second busbar 40 in the illustrated embodiment extends through the second core 22 and includes the above-described additional segments at its first and second ends of the main segment, but its ends are reversed in comparison to the first busbar 30. As noted above, it is to be understood that the additional segments of the first busbar 30 and the second busbar 40 may vary in number, orientation and dimension when compared to the illustrated embodiments.

By using the busbar 16 as the choke conductor, two welds per coil are eliminated. This has a positive impact on cost, resistance, and reliability. The choke cores 14 can be manufactured from soft magnetic composite materials from alloys such as iron, iron silicon, iron nickel, etc.

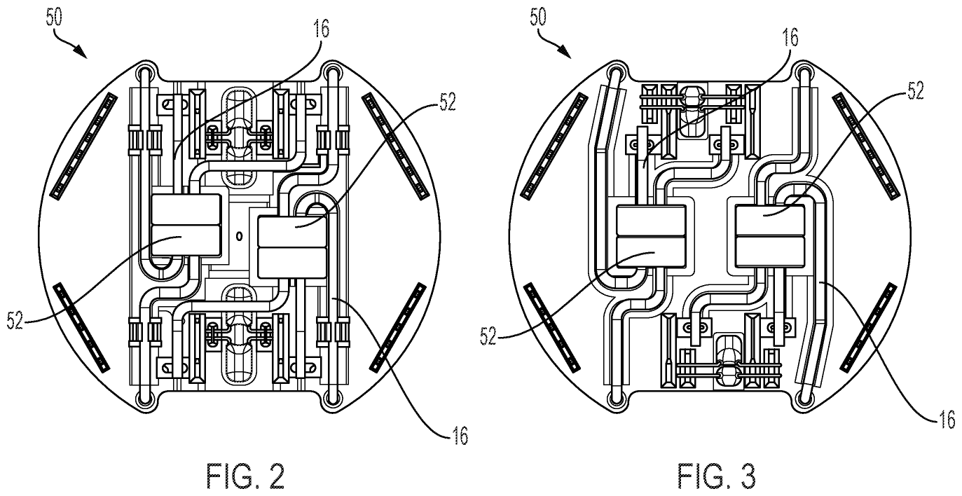

Referring now to FIGS. 2 and 3, a header assembly having a common mode choke arrangement is illustrated and is referenced generally with numeral 50. In the illustrated embodiments, the cores 52 are hollow cylindrical structures, as with the embodiment of FIGS. 1 and 1A, but the length of the cores 52 is shorter when compared to the cylinder of FIGS. 1 and 1A. FIGS. 2 and 3 differ simply by the routing scheme of the conductor wire busbars 16.

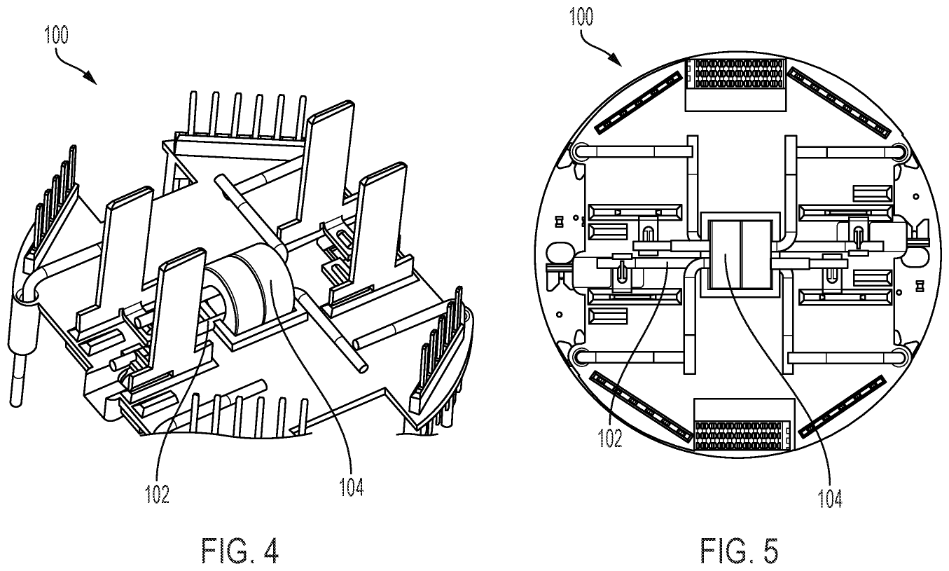

FIGS. 4 and 5 illustrate another embodiment of a header assembly that includes a common mode choke arrangement and is referenced generally with numeral 100. In the illustrated embodiment, the conductor wire busbars 102 pass through a single core 104.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

Having thus described the invention, it is claimed:

1. A header assembly for a power pack assembly comprising:
a frame;
a core disposed on or within the frame; and
a conductor busbar extending through the core and secured to the frame, wherein the conductor busbar has a round cross-section.

2. The header assembly of claim 1, wherein the conductor busbar is a copper cylindrical member.

3. The header assembly of claim 1, wherein the core is a hollow cylindrical member.

4. The header assembly of claim 1, wherein the frame is a molded plastic component.

5. The header assembly of claim 1, wherein the core is a first core and the conductor busbar is a first conductor busbar, the header assembly further comprising:
a second core disposed on or within the frame, where the second core is a hollow cylindrical member; and
a second conductor busbar, wherein the second conductor busbar extends through the second core and is secured to the frame.

6. The header assembly of claim 5, wherein the second conductor busbar is a copper cylindrical member.

7. The header assembly of claim 1, wherein the core is formed of a soft magnetic composite material.

8. The header assembly of claim 7, wherein the core is formed of one of an iron alloy, an iron silicon alloy, and an iron nickel alloy.

9. The header assembly of claim 1, wherein the header assembly includes a common mode choke arrangement.

10. The header assembly of claim 1, wherein the header assembly includes a differential mode choke arrangement.

11. The header assembly of claim 1, wherein the conductor busbar extending through the core is a single conductor busbar.

12. A header assembly for a power pack assembly in a vehicle steering system comprises:
a frame;
a first core disposed on or within the frame;
a second core disposed on or within the frame;
a first conductor busbar extending through the first core and extending through a hole defined by the frame, wherein the first conductor busbar has a round cross-section; and
a second conductor busbar extending through the second core and extending through a hole defined by the frame, wherein the second conductor busbar has a round cross-section.

13. The header assembly of claim 12, wherein at least one of the first conductor busbar and the second conductor busbar is a copper cylindrical member.

14. The header assembly of claim 12, wherein each of the first core and the second is a hollow cylindrical member.

15. The header assembly of claim 12, wherein the frame is a molded plastic component.

16. The header assembly of claim 12, wherein the second conductor busbar is a copper cylindrical member.

17. The header assembly of claim 12, wherein the first core and the second core are formed of a soft magnetic composite material.

18. The header assembly of claim 17, wherein each of the first core and the second core is formed of one of an iron alloy, an iron silicon alloy, and an iron nickel alloy.

19. The header assembly of claim 12, wherein the header assembly includes a common mode choke arrangement.

20. The header assembly of claim 12, wherein the header assembly includes a differential mode choke arrangement.
